(19) United States
(12) Patent Application Publication
(10) Pub. No.: US 2004/0029009 A1
(43) Pub. Date: Feb. 12, 2004

(54) Lithium secondary battery

(76) Inventors: Tsutomu Sada, Otsu-shi (JP); Kazunari Takeda, Tsurugashima-shi (JP); Yumiko Takashima, Tano-gun (JP); Naoto Mishimura, Kashihara-shi (JP); Takehito Mitate, Yamatotakada (JP); Kazuo Yamada, Kitakatsuragi-gun (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/381,515

(22) PCT Filed: Sep. 28, 2001
(86) PCT No.: PCT/JP01/08526

(30) Foreign Application Priority Data
Sep. 29, 2000 (JP) 2000297772

(51) Int. Cl. H01M 4/58; H01M 10/40

(52) U.S. Cl. 429/231.4; 429/303; 429/317

(57) ABSTRACT

A lithium secondary cell with a small decrease in discharge capacity during high-load discharge and little self-discharge. The electrolytic layers of the cell consist of positive-side and negative-side polymer electrolytic layers integrated with their respective electrodes, wherein the positive-side electrolytic layer is lower than the negative-side electrolytic layer indirect current resistance.

### FIELD OF THE INVENTION

This invention relates to a lithium secondary battery which includes a polymer electrolyte.

### BACKGROUND ART

Much interest has been drawn to lithium ion batteries having a high energy density due to the popularization of small size, portable electronic instruments. In order to develop still lighter and thinner batteries having improved safety, vigorous studies are made to develop a battery using a solid electrolyte, i.e. a polymer electrolyte. However, the use of solid electrolyte tends to decrease the mobility of ions and increase the interfacial resistance between the solid electrolyte and the electrodes which leads to the failure of recovery of sufficiently large amount of energy at a high current level. Accordingly, many developments have been made and disclosed addressing the problems of how the ion conductivity of the solid electrolyte may be improved and how the interfacial resistance between the solid electrolyte and the electroactive substance of the respective electrodes may be decreased.

Besides a problem remains to exist on the capacity preserving characteristics of charged battery, namely greater self-discharge owing to uncontrolled interfacial resistance between the solid electrolyte and the electroactive substance of respective electrodes.

### DISCLOSURE OF THE INVENTION

In order to solve the above problems, we have found that the relationship of DC resistance between the solid electrolyte on the anode and the solid electrolyte on the cathode is critical, in addition to the improvement of ion-conductivity of the solid electrolyte to decrease interfacial resistance between the solid electrolyte and the electrode already studies heretofore, for the lithium secondary battery of a type having an electrolyte layer prepared by joining a polymer elctrolyte sub-layer integrally formed on the anode and a polymer electrolyte sub-layer integrally formed on the cathode together.

Accordingly, the present invention provides a lithium secondary battery comprising an anode having an electroactive substance layer comprised of a carbonaceous material capable of electrochemicaly inclusion and release of lithium, a cathode having an electroactive substance layer comprised of a chalcogenide compound containing lithium, and a solid electrolyte layer sandwiched between the cathode and the anode.

The battery according to the present invention is characterized in that said electrolyte layer is comprised of a polymer electrolyte sub-layer formed integrally with the cathode and a polymer electrolyte sub-layer formed integrally with the anode, and that DC resistance is lower in said sub-layer on the cathode than in said sub-layer on the anode.

The lower DC resistance in the sub-layer on the cathode provides the following advantages.

1) The internal resistance within the battery may be decreased to thereby improve the discharge characteristics upon discharge at high loads.

2) Since the DC resistance is higher in the electrolyte sub-layer on the anode than the electrolyte sub-layer on the cathode, the self-discharge of lithium ions from the anode is retarded and, therefore, the self-discharge in the entire battery is retarded correspondingly.

### BEST MODE FOR CARRYING OUT OF THE INVENTION

The battery of the present invention may be manufactured by forming an ion-conductive polymer layer separately on a pre-fabricated cathode and anode and joining the layers together although the manufacturing process is not limited thereto.

Basically, the anode and cathode comprise a current collector in the form of a metal foil and an electroactive substance of the respective electrodes bound with a binder material. The materials of the collector foil include aluminum, stainless steel, titanium, copper, nickel and the like. Aluminum and copper are employed for the cathode and the anode, respectively in consideration of their electrochemical stability, ductility and economy.

Although metal foils are mainly shown herein as the form of anode and cathode collectors, other forms such as mesh, expanded metals, laths, perforated sheets or plastic films having a coating of an electron-conductive material may be employed although the form of collector is not limited thereto.

The electroactive substance of the anode is a carbonaceous materical capable electrochemically inclusion and release of lithium. Typical examples thereof include particles (flakes, aggregates, fibers, whiskers, beads or ground particles) of natural or artificial graphite. Artificial graphite produced by graphitizing mesocarbon beads, mesophase pitch powder or isotropic pitch powder may also be used.

With regard to the electroactive substance used in the present invention, it is more preferable to use as the carbonaceous material graphite particles having attached to the surfaces thereof amorphous carbon particles. These particles may be obtained by dipping the graphite particles in a coal-based heavy oil such as pitch or a petroleum-based heavy oil and heating recovered graphite particles to a temperature above the carbonizing temperature to decompose the heavy oil, if necessary, followed by milling. Such treatment significantly retards the decomposing reaction of the nonaqueous electrolyte solution and the lithium salt occurring at the anode during the charge cycle to enable the charge and discharge cycle life to be improved and also the gas evolution due to the above decomposition reaction to be prevented. In the above carbonaceous material, micropores contributing to increase in BET specific surface area have been filled with the attached carbon particles derived from the heavy oil. The specific surface area thereof is generally below 5 m²/g, preferably in the range between 1 to 5 m²/g. Greater specific surface areas are not preferable because increased contacting surface area with the ion-conductive polymer makes undesired side reactions to be taken place more easily.

The cathodic electroactive substance to be used in the present invention in conjunction with the carbonaceous anodic active substance is preferably selected from a composite oxide of laminar or spinel structure represented by the formula: Liₐ(A)_{b}(B)_{c}O₂

wherein

A is a transition metal element;

B is an element selected from the group consisting of a non-metal or semi-metal element of group 3B, 4B and 5B of the periodic chart, an alkaline earth metal, Zn, Cu and Ti;

a, b and c are numbers satisfying the following relationship:

0≦a≦1.15

0.85≦b+c≦1.30, and

c>0

Typical examples of the composite oxides include LiCoO₂, LiNiO₂ and LiCoxNi₁₋ₓO₂ (0<x<1). Use of these compounds in conjunction with a carbonaceous material as a anodic electroactive substance is advantageous in that the battery exhibits a practically acceptable dynamic voltage even when the voltage variation generated by charging and discharging the carbonaceous material per se (about 1 volt vs. Li/Li⁺), and that lithium ions necessary for charging and discharging the battery are already contained in the form of, for example, LiCoO₂ or LiNiO₂ before assembling the battery.

When preparing the anode and cathode, the respective electroactive substances may be combined, where necessary, with a chemically stable conductor material such as graphite, carbon black, acetylene black, carbon fiber or conductive metal oxides to improve the electron conductivity thereof.

The binder is selected among those thermoplastic resins which are chemically stable, soluble in a suitable solvent but hardly attacked with the nonaqueous electrolyte solution. A variety of such thermoplastic resins have been known. For example, polyvinylidene fluoride (PVDF) may preferably used since this resin is selectively soluble in N-methyl-2-pyrrolidone. Other examples of usable thermoplastic resins include polymers and copolymers of acrylonitrile, methacrylonitrile, vinyl fluoride, chloroprene, vinyl pyridine and its derivatives, vinylidene chloride, ethylene, propylene and cyclic dienes (e.g. cyclopentadiene, 1,3-cyclohexadiene). A dispersion of the binder resin may also be used in place of a solution.

The electrode may be produced by kneading the respective electroactive substances and, where necessary, the conductor material with a solution of the binder resin to prepare a paste, applying the paste on a metal foil using a suitable coater to form a film of uniform thickness, and compressing the film after drying. The proportion of the binder resin in the electroactive substance layer should be minimum and generally lies from 1 to 15% by weight. The proportion of the conductor material usually lies, when used, from 2 to 15% by weight of the electroactive substance layer.

The polymer electrolyte layer is formed on the respective electroactive substance layers thus prepared integrally therewith. The polymer electrolyte layer is comprised of a matrix of an ion-conductive polymer impregnated with or retaining a nonaqueous electrolyte solution containing a lithium salt. The polymer electrolyte layer occurs macroscopically in a solid state but microscopically retains a continuous phase of the lithium solution formed therein in situ. The polymer electrolyte layer of this type has an ion-conductivity higher than that of the corresponding polymer electrolyte free from the lithium solution.

The polymer electrolyte layer may be formed by polymerizing (heat polymerization, photopolymerization etc.) a precursor monomer of the ion-conductive polymer in the form, of a mixture with the nonaqueous electrolyte solution containing a lithium salt.

The monomer component of the above mixture which can be used for this purpose should include a polyether segment and also be polyfunctional in respect to the polymerization site so that the resulting polymer forms a three dimensional crosslinked gel structure. Typically, such monomers may be prepared by esterifying the terminal hydroxyl groups with acrylic or methacrylic acid (collectived called “(meth)acrylic acid”). As is well known in the art, polyether polyols are produced by addition-polymerizing ethylene oxide (EO) alone or in combination with propylene oxide (PO) using an initiator polyhydric alcohol such as ethylene glycol, glycerine or trimethylolpropane. A monofunctional polyether polyol (meth)acrylate may be used in combination with polyfunctional monomers.

The poly- and monofunctional monomers are typically represented by the following general formulas:

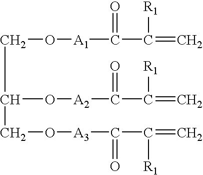

wherein R₁ is hydrogen or methyl;

A₁, A₂ and A₃ are each a polyoxyalkylene chain containing at least 3 ethylene oxide (EO) units and optionally some propylene oxide (PO) units such that PO/EO=0-5 and EO+PO≧35.

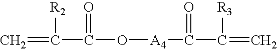

wherein R₂ and R₃ are hydrogen or methyl:

A₄ is a polyoxyalkylene chain containing at least 3 EO units and optionally some PO units such that PO/EO==0-5 and EO+PO≧10.

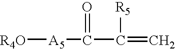

wherein R₄ is a lower alkyl, R₅ is hydrogen or methyl, and A₅ is a polyoxyalkylene chain containing at least 3 EO units and optionally some PO units such that PO/EO=0-5 and EO+PO≧3.

The nonaqueous electrolyte solution is prepared by dissolving a lithium salt in a nonpolar, aprotic organic solvent. Non-limitative examples of the lithium salt solutes include LiClO₄ LiBF₄, LiAsF₆, LiPF₆ LiI, LiBr, LiCF₃SO₃, LiCF₃CO₂, LiNC(SO₂CF₃)₂, LiN(COCF₃)₂, LiC(SO₂CF₃)₂, LiSCN and mixtures thereof.

Non-limitative examples of the organic solvents include cyclic carbonate esters such as ethylene carbonate (EC) or propylene carbonate (PC); straight chain carbonate esters such as dimethyl carbonate (DMC), diethyl carbonate (DEC) or ethyl methyl carbonate (EMC); lactones such as γ-butyrolactone (GBL); esters such as methyl propionate or ethyl propionate; ethers such as tetrahydrofuran and its derivatives, 1,3-dioxane, 1,2-dimethoxyethane, or methyl diglyme; nitrites such as acetonitrile or benzonitrile; dioxolane and derivatives thereof; sulfolane and derivatives thereof; and mixtures of these solvents.

Since the polymer electrolyte on the electrode, particularly on the carbonaceous material of the anode is required to contain a nonaqueous electrolyte solution of which side reactions with the graphite-based carbonaceous material are retarded, it is preferable to use a solvent system consisting primarily of EC and another solvent selected from PC, GBL, EMC, DEC or DMC. For example, a nonaqueous electrolyte solution containing 3 to 35% by weight of a lithium salt dissolved in the above solvent mixture containing 2 to 50% by weight of EC exhibits a satisfactory ion conductivity even at low temperatures.

The proportion of the nonaqueous solution in the mixture with the precursor monomer should be large enough to maintain the solution as continuous phase in the crosslinked polymer electrolyte layer but should not be so excessive to undergo phase separation and bleeding of the solution from the gel. This can be accomplished by the ratio of the monomer to the electrolyte solution generally within a range from 30/70 to 2/98, preferably within a range from 20/80 to 2/98 by weight.

The polymer electrolyte layer may optionally include a porous substrate as a support member. Such substrate may be either a microporous membrane made from a polymer which is chemically stable in the nonaqueous electrolyte solution e.g. polypropylene, polyethylene or polyester, or a sheet (i.e. paper or nonwoven fabric) made from fiber of such poymers. It is preferable, that the substrate has a air permeability from 11 to 500 sec./cm³ and can retain the polymer electrolyte therein at a substrate: polymer electrolyte ratio from 91/9 to 50:50. This is necessary to achieve an optimum balance between the mechanical strength and the ion conductivity.

When the substrate is not used, the polymer electrolyte layer integral with the respective electrode may be fabricated by casting the mixture of the precursor monomer and the nonaqueous electrolyte solution on the respective electroactive substance layers to form a film and polymerization the monomer in situ. Then both electrodes are joined together with their polymer electrolyte layers facing inwardly.

When used, the substrate is applied on the electroactive substance layer of either one of the electrodes. Then the mixture of the precursor monomer and the electrolyte solution is cast on the substrate followed by polymerization of the monomer in situ to form the polymer electrolyte layer integral with the substrate and the electrode. This electrode is joined together with the other electrode including the polymer electrolyte layer free of the substrate formed as above with their polymer electrolyte layers facing inwardly.

The above methods are preferred since they insure to form the polymer electrolyte layer integral with the electrode and the substrate, when used, in a simple manner.

The mixture of the precursor of ion-conductive polymer (monomer) and the nonaqueous electrolyte solution containing a lithium salt contains a suitable polymerization initiator depending on the polymerization method, e.g. a peroxide type or azo type initiator for heat polymerization and a photoinitiator such as acetophenone, benzophenone or phosphine series for photopolymerization. The polymerization initiator may be used in an amount from 100 to 1,000 ppm and should not be used in excess.

According to the present invention, the polymer electrolyte layer sandwiched between the cathode and the anode is comprised of a pair of sub-layers and the DC resistance of the sub-layer on the cathode is lower than the DC resistance of the sub-layer on the anode. An exemplifying method for effectuating this is to increase the concentration of lithium salt in the polymer electrolyte sub-layer on the cathode to a level higher than the lithium salt concentration in the polymer electrolyte sub-layer on the anode. As stated before, the polymer electrolyte is comprised of a matrix of ion-conductive polymer retaining a nonaqueous electrolyte solution containing a lithium salt. Therefore, lower DC resistance in the polymer electrolyte sub-layer on the cathode may be effectuated by adjusting the lithium salt concentration in the precursor solution of the polymer electrolyte (mixture of a precursor monomer of ion-conductive polymer and the nonaqueous electrolyte solution) at a higher level on the cathode side than on the anode side. Specifically, the method includes 1) by adjusting the lithium salt concentration while maintaining the ratio of the electrolyte solution to the monomer at constant, 2) by varying said ratio while maintaining the lithium salt concentration in the electrolyte solution at constant, or 3) by varying both the ratio of the electrolyte solution to the monomer and the lithium salt concentration in the electrolyte solution. When using electrolyte solutions having different lithium concentrations, it is preferable to adjust the concentration from 1.0 to 3.5 mol/L, more preferably from 1.0 to 2.75 mol/L on the cathode side, and from 0.7 to 2.0 mol/L on the anode side.

### EXAMPLE

The following Examples are for illustrative purpose only and not intended to limit the scope of the present invention thereto.

### Example 1

1) Fabrication of Anode

100 weight parts of artificial graphite (d002=0.336, average particle size=12 μm, R=0.15, specific surface area=4 m²/g) were taken in a mortar and milled with a solution of 9 weight parts of polyvinylidene fluoride (PVDF) dissolved in an appropriate amount of N-methylpyrrolidone (NMP). The resulting paste was applied onto a copper foil of 18 μm thickness, dried and compressed. The foil was cut into 3.5×3.0 cm size before applying the paste in 3×3 cm area. A nickel foil of 50 μm thickness was welded to the uncoated edge of the copper foil as a lead. The total thickness of the anode was 70 μm.

2) Fabrication of Cathode

100 weight parts of LiCoO₂ having an average particle size of 7 μm and 5 weight parts of acetylene black were taken in a mortar and milled with a solution of 5 weight parts of PVDF dissolved in an appropriate amount of NMP. The resulting paste was applied on an aluminum foil of 20 μm thickness, dried and compressed. The foil was cut into 3.5×3.0 cm size before applying the paste in 3×3 cm area. An aluminum foil of 50 μm thickness was welded to the uncoated edge of the electrode foil as a lead. The total thickness of the cathode was 80 μm.

3) Preparation of Polymer Electrolyte Precursor Solution for Anode

L₁—PF₆ was dissolved to 1 mol/L concentration in a 1:1 mixture by volume of ethylene carbonate (EC) and γ-butyrolactone (GBL) to prepare a nonaqueous electrolyte solution.

To 90 weight parts of this solution were added 10 weight parts of a trifunctional polyether polyol triacrylate (MW=7500-9000) of the formula:

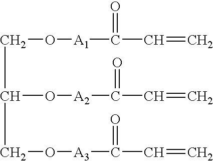

wherein A₁, A₂ and A₃ are each polyoxyalkylene chain containing at least 3 EO units and at least one PO unit in PO/EO ratio of 0.25. Then 2,2-dimethoxy-2-phenylacetophenon (DPAP) was added to the monomer-electrolyte solution mixture at a concentration of 500 ppm.

4) Preparation of Polymer Electrolyte Precursor Solution for Cathode

LiBF₄ was dissolved to 2 mol/L concentration in a 1:1 mixture by volume of EC and GBL.

5) Fabrication of Polymer Electrolyte Sub-Layer on the Respective Electrodes Integrally Therewith.

The cathode and the anode were impregnated with their respective polymer electrolyte precursor solutions and placed in a space having a constant spacing distance defineded by a pair of glass plates and a space member. The elctroactive substance layer of each electrode was then irradiated with UV radiation of 365 μm wavelength at an intensity of 40 mW/cm² for 2 minutes. The thickness of the resulting polymer electrolyte sub-layer was 20 μm both for the cathode and the anode.

6) Assembly of Battery

The cathode and the anode each having a polymer electrolyte layer formed integrally therewith by the above procedures were joined together with their polymer electrolyte layers facing inwardly to produce a battery.

7) Measurement of DC Resistance

An independent polymer electrolyte sheet was produced. The monomer/electrolyte solution mixtures used in steps 3) and 4) were each poured into the space having a constant spacing distance defined a pair of glass plates and a spacer member as used in step 5) and irradiated with UV radiation under the same conditions as in step 5). The resulting polymer sheet was clamped between a pair of electrodes having a gold plating thereon (the width of electrode=19 mm) and then DC was applied on the polymer electrolyte sheet at a voltage of 4V for 30 seconds. The DC resistance was calculated based on the current value measured after application of DC for 30 seconds.

### Comparative Example 1

Example 1 was repeated except that the monomer/electrolyte solution mixture used in step 3) (LiBF₄=1 mol/L) was also used in the fabrication of the polymer electrolyte sub-layer on the cathode.

### Example 2

1) Fabrication of Anode

Step 1) of Example 1 was followed except that graphite powder having amorphous carbon material attached to the surfaces of graphite particles was used as an anodic electroactive substance.

2) Fabrication of Cathode

Same as step 2) of Example 1.

3) Preparation of Polymer Electrolyte Precursor Solution for Cathode

LiPF₆ was dissolved to 1 mol/L concentration in a 1:1 volumetric mixture of EC and GBL.

To 90 weight parts of this solution were added 1.5 weight parts of a trifunctional polyether polyol triacrylate (MW=7500-9000) of the formula:

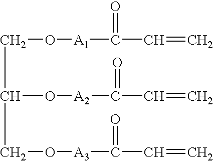

wherein A₁, A₂ and A₃ are each polyoxyalkylene chain containing at least 3 EO units and at least one PO unit in PO/EO ratio of 0.25, and 3.5 weight parts of a monofunctional polyether polyol methyl ether monoacrylate having a melecular weight from 2,500 to 3,000 of the formula:

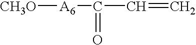

wherein A₆ is a polyoxyalkylene chain containing at least 3 EO units and at least one PO unit in PO/EO ratio of 0.25. Then 500 ppm of DMPA was added to prepare a polymer electrolyte precursor solution for anode.

4) Preparation of Polymer Electrolyte Precursor Solution for Cathode

LiBF₄ was dissolved to 2.5 mol/L concentration in a mixture of EC, GBL and propylene carbonate (PC) at a volumetric ratio of 35:35:30.

To 95 weight parts of this solution were added 1.5 weight parts of the trifunctional polyether polyol polyacrylate used in step 3), and 3.5 weight parts of triethylene glycol monomethyl ether acrylate of the formula:

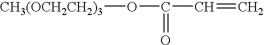

Then 500 ppm of DMPA was added to prepare a polymer electrolyte precursor solution for cathode.

5) Fabrication of Polymer Electrolyte Sub-Layers on the Respective Electrodes Integrally Therewith.

Same as step 5) of Example 1 except that the polymer electrolyte precursor solutions prepared steps 3) and 4) were used.

Assembly of battery and the measurement of DC resistance were performed as in Example 1.

### Comparative Example 2

Example 2 was repeated except that the polymer electrolyte precursor solution used in step 3) (LiBF₄=1 mol/L) was also used in the fabrication of the polymer electrolyte sub-layer on the cathode.

### Example 3

1) Fabrication of Anode

Same as the anode of Example 2

2) Fabrication of Cathode

Same as the cathode of Example 2

3) Preparation of polymer electrolyte precursor solution for anode

LiBF₄ was dissolved to 1 mol/L concentration in a mixture of EC, GBL and PC at a volumetric ratio of 35:35:30.

To 95 weight parts of this solution were added 2.5 weight parts of the trifunctional polyether polyol polyacrylate having a molecular weight of 7,500-9,000 used in step 3) of Example 2, and 2.5 weight parts of the monofunctional polyether polyol monomethyl ether monoacrylate having a molecular weight of 2,500-3,000 used in step 3) of Example 2. Then 500 ppm of DMPA was added to prepare a polymer electrolyte precursor solution for anode.

4) Preparation of Polymer Electrolyte Precursor Solution for Cathode.

LiBF₄ was dissolved to 1 mol/L concentration in a mixture of EC and GBL at a volumetric ratio of 1:1.

To 97 weight parts of this solution were added to 2.1 weight parts of the trifunctional polyether polyol polyacrylate having a molecular weight of 7,500-9,000 used in step 3), and 0.9 weight parts of triethylene glycol monomethyl ether monoacrylate used in step 4) of Exmaple 2. Then 500 ppm of DMPA was added to prepare a polymer electrolyte precursor solution for cathode.

5) Fabrication of Polymer Electrolyte Sub-Layers on the Respective Electrodes Integrally Therewith

Same as Example 1 except that the polymer electrolyte precursor solutions prepared steps 3) and 4) were used.

Assembly of battery and the measurement of DC resistance were performed as in Example 1.

The batteries of Examples 1-3 and Comparative Examples 1-2 were discharged at a constant current of 0.2C and 1C, respectively. The battery were also discharged at a constant current of 0.2C after charging to a saturation level and storing at room temperature for one month. Discharge capacities of the batteries at each test and the DC resistance levels of polymer electrolyte sub-layers are shown in Table 1 below.

As indicated by the data given in Table 1, the batteries of Examples in which the polymer electrolyte sub-layer on the cathode has lower DC resistance than the polymer electrolyte sub-layer on the anode were excellent in the discharge characteristics even at a high load discharge of 1C. The batteries of Examples charged to saturation level maintained almost the same discharge capacity level even after storing at room temperature for one month. It was also observed that the self-discharge was minimum in the batteries of Examples 1-3.

When-comparison is made between batteries of Example 1 and Example 2, it is understood that the self-discharge is less in the battery of Example 2 than in the battery of Example 1. This is considered to be attributable to retarded side reactions with the polymer electrolyte by the attachment of amorphous carbon on the surfaces of graphite particles.

TABLE 1

| | Discharge | | Discharge capacity | DC resistance | |
|---|---|---|---|---|---|
| | capacity (mAh) | | after one month | (ohm) | |
| | 0.2 C | 1 C | 0.2 C | Anode | Cathode |
| Ex. 1 | 23 | 16 | 21 | 212 | 315 |
| Ex. 2 | 25 | 20 | 24 | 153 | 352 |
| Ex. 3 | 25 | 22 | 24 | 151 | 350 |
| Comp. Ex. 1 | 22 | 8 | 18 | 315 | 315 |
| Comp. Ex. 2 | 23 | 11 | 14 | 235 | 235 |

1. A lithium secondary battery comprising an anode having an electroactive substance layer comprised of a carbonaceous material capable of electrochemically inclusion and release of lithium, a cathode having an electroactive substance layer comprised of a chalcogenide compound containing lithium, and a solid electrolyte layer sandwiched between the cathode and the anode, wherein said solid electrolyte layer is comprised of an electrolyte sub-layer formed integrally with the anode and an electrolyte sub-layer formed integrally with the cathode, and wherein DC resistance is lower in said sub-layer on the cathode than in said sub-layer on the anode.

2. The lithium secondary battery according to claim 1 wherein said solid electrolyte layer is comprised of a polymer gel comprising a matrix of ion-conductive polymer retaining a nonaqueous electrolyte solution containing a lithium salt therein.

3. The lithium secondary battery according to claim 2 wherein said polymer electrolyte is produced by the crosslinking polymerization reaction of a precursor monomer of said ion-conductive polymer in a mixture thereof with said nonaqueous electrolyte solution in situ, and wherein said electrolyte sub-layers having high and low DC resistance are prepared 1) by adjusting the lithium salt concentration of the nonaqueous electrolyte solution while maintaining the ratio of the electrolyte solution to the monomer at constant, 2) by varying said ratio while maintaining the lithium salt concentration in the electrolyte solution at constant, or 3) by varying both said ratio and lithium salt concentration.

4. The lithium secondary battery according to claim 2 wherein said ion-conductive polymer is a homo- or copolymer of polyether polyol (meth)acrylate containing an ethylene oxide (EO) unit and optionally a propylene unit in the polyether chain.

5. The lithium secondary battery according to claim 2 wherein the solvent of said nonaqueous electrolyte solution is selected from the group consisting of ethylene carbonate, prepylene carbonate, ethyl methyl carbonate, dimethyl carbonate, diethyl carbonate, γ-butyrolactone and a mixture thereof.

6. The lithium secondary battery according to claim 1, said electroactive substance of said anode is a particulate graphite having amorphous carbon attached to the surfaces thereof.
